(19) United States
(12) Patent Application Publication
(10) Pub. No.: US 2023/0206255 A1
(43) Pub. Date: Jun. 29, 2023

(54) Automated Customer Trust Measurement and Insights Generation Platform

(71) Applicant: Google LLC, Mountain View, CA (US)

(72) Inventors: Rui Zhong, San Francisco, CA (US); Xu Gao, Santa Clara, CA (US); Colleen Conway Walsh, Huntington, NY (US); Aditya Padala, Sunnyvale, CA (US); Hirak Mondal, Hyderabad (IN); Dayu Yuan, Mountain View, CA (US); Ngoc Thuy Le, San Jose, CA (US); Zi Yang, Fremont, CA (US); Pradhat Kiran Bharathidhasan, San Jose, CA (US); Sarath Balasubramaniam Ramachandran, San Jose, CA (US)

(73) Assignee: Google LLC, Mountain View, CA (US)

(21) Appl. No.: 17/646,142

(22) Filed: Dec. 27, 2021

(51) Int. Cl. G06Q 30/02; G06F 40/30; G06N 20/00

(52) U.S. Cl. CPC G06Q 30/0201; G06F 40/30; G06N 20/00

(57) ABSTRACT

A method for predicting a customer trust target metric includes receiving, from a business, a customer trust target metric definition defining a customer trust target metric customized by the business. The method also includes obtaining sentiment data representative of one or more interactions between a customer and the business. The sentiment data includes textual feedback data and non-textual metadata. The method also includes determining, using a natural language processing model, a sentiment score of the sentiment data. Further, the method includes predicting, using the sentiment score and the customer trust target metric definition, a respective customer trust target metric for a respective one of the one or more interactions between the customer and the business. The method also includes sending, to the business, the predicted respective customer trust target metric.

### TECHNICAL FIELD

This disclosure relates to automated customer trust measurement and insights generation.

### BACKGROUND

It is important for a business to measure and understand the level of customer trust of their customers. An accurate measure of customer trust may provide the business with valuable insight into their relationships with their customers as well as areas where they can improve service to their customers. Unfortunately, traditional approaches for determining customer trust, such as surveys, have several drawbacks including poor coverage, low response rates, pre-defined and/or limited scope, and biases in the response data.

### SUMMARY

One aspect of the disclosure provides a computer-implemented method for predicting a customer trust target metric. The computer-implemented method when executed by data processing hardware causes the data processing hardware to perform operations that include receiving, from a business, a customer trust target metric definition defining a customer trust target metric customized by the business. The operations also include obtaining sentiment data representative of one or more interactions between a customer and the business. The sentiment data includes textual feedback data and non-textual metadata. The operations also include determining, using a natural language processing model, a sentiment score of the sentiment data. Further, the operations include predicting, using the sentiment score and the customer trust target metric definition, a respective customer trust target metric for a respective one of the one or more interactions between the customer and the business. The operations also include sending, to the business, the predicted respective customer trust target metric.

Implementations of the disclosure may include one or more of the following optional features. In some implementations, the customer trust target metric includes a survey response. In some examples, the operations further include, prior to determining the sentiment score, training, using historical sentiment data, actual trust target metrics provided by customers, and the customer trust target metric definition, the natural language processing model. The non-textual metadata may include at least one of a length of time the customer has been associated with the business, a quantity of the one or more interactions, or a subscription level associated with the customer. Further, the textual feedback data may include at least one of transcribed audio conversations, emails, chat messages, or meeting notes.

In some examples, the operations further include determining, using the natural language processing model and the sentiment data, one or more topics associated with the one or more interactions between the customer and the business that influence the predicted respective customer trust target metric. In these examples, determining the one or more topics may include converting, using language embedding, the textual feedback data into numerical inputs. Alternatively, determining the one or more topics may include generating a graph using contextual graph-based sampling of the sentiment data. In some of these examples, determining the one or more topics may include selecting a plurality of nodes of the graph for human labeling. Alternatively, determining the one or more topics may include training, using the plurality of human labeled nodes, a label propagation model and predicting, using the label propagation model, a label for each node of the graph.

Another aspect of the disclosure provides a system for predicting a customer trust target metric. The system includes data processing hardware and memory hardware in communication with the data processing hardware. The memory hardware stores instructions that when executed on the data processing hardware causes the data processing hardware to perform operations. The operations include receiving, from a business, a customer trust target metric definition defining a customer trust target metric customized by the business. The operations also include obtaining sentiment data representative of one or more interactions between a customer and the business. The sentiment data includes textual feedback data and non-textual metadata. The operations also include determining, using a natural language processing model, a sentiment score of the sentiment data. Further, the operations include predicting, using the sentiment score and the customer trust target metric definition, a respective customer trust target metric for a respective one of the one or more interactions between the customer and the business. The operations also include sending, to the business, the predicted respective customer trust target metric.

This aspect may include one or more of the following optional features. In some implementations, the customer trust target metric includes a survey response. In some examples, the operations further include, prior to determining the sentiment score, training, using historical sentiment data, actual trust target metrics provided by customers, and the customer trust target metric definition, the natural language processing model. The non-textual metadata may include at least one of a length of time the customer has been associated with the business, a quantity of the one or more interactions, or a subscription level associated with the customer. Further, the textual feedback data may include at least one of transcribed audio conversations, emails, chat messages, or meeting notes.

In some examples, the operations further include determining, using the natural language processing model and the sentiment data, one or more topics associated with the one or more interactions between the customer and the business that influence the predicted respective customer trust target metric. In these examples, determining the one or more topics may include converting, using language embedding, the textual feedback data into numerical inputs. Alternatively, determining the one or more topics may include generating a graph using contextual graph-based sampling of the sentiment data. In some of these examples, determining the one or more topics may include selecting a plurality of nodes of the graph for human labeling. Alternatively, determining the one or more topics may include training, using the plurality of human labeled nodes, a label propagation model and predicting, using the label propagation model, a label for each node of the graph.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for predicting a customer trust target metric of a customer of a business.

FIG. 2 is a schematic view of exemplary training of a trust analyzer model of the system of FIG. 1.

FIG. 3 is a schematic view of inputs to a trust analyzer model for predicting a customer trust target metric of a customer of a business.

FIG. 4 is a schematic view of an example graph generated by the trust analyzer model of FIG. 1.

FIG. 5 is a flowchart of an example arrangement of operations for a method of predicting a customer trust target metric of a customer of a business.

FIG. 6 is a schematic view of an example computing device that may be used to implement the systems and methods described herein.

Like reference symbols in the various drawings indicate like elements.

### DETAILED DESCRIPTION

Customer trust is a metric indicating a level of belief or satisfaction a customer has in a business. Many businesses have difficulties accurately measuring customer trust due to deficiencies in conventional methods. The most common conventional method includes the use of surveys or other feedback from customers. However, the data gained from surveys may be flawed as the questions may be narrowly tailored. Further, customer response rates to surveys are typically low and responses often take days to weeks to receive. Moreover, the data obtained can be skewed as customers with more extreme sentiments, good or bad, are generally more likely to respond to surveys and/or provide feedback.

While the use of surveys may be limiting, there are a wide variety of other sources of data that can be used to evaluate customer trust. However, these other sources of data remain largely untapped for use in determining customer trust as conventional systems are unable to process and analyze these data sets effectively. For example, customers may interact with a business through phone calls, emails, or chats. In addition to the actual content of these conversations, metadata (e.g., non-textual data such as length, tone, time of day, etc.) include insights that may be used to evaluate customer trust. Other metadata related to the customer, such as a length of time the customer has been a patron of the business, may also indicate the level of customer trust.

Implementations herein set forth systems and methods to predict a customer trust target metric of a business using sentiment data including textual feedback and non-textual metadata. Textual feedback may include, as non-limiting examples, transcribed phone calls, emails, chats, notes, and other internal sources of data regarding the customer that is saved in a text-based format. Further, textual feedback may also include data obtained from external sources, such as customer posts to open forums (e.g., social media). Non-textual data can include metadata related to the customer's patronage of the business, such as the frequency and type of contact a customer has with a business, the length of customer's relationship with the business, the status of the customer's relationship with the business, the products the customer uses/purchases, etc.

As discussed in greater detail below, implementations herein use a natural language processing (“NLP”) model to evaluate the sentiment data (i.e., the textual data and non-textual metadata) to determine a sentiment score which may be used to predict a customer trust target metric. The NLP model may also determine one or more topics associated with one or more interactions between the customer and the business that influence the predicted customer trust target metric. The NLP model may be trained based on the requirements and data available for a particular business such that the NLP model may be fully customizable based on the needs of the business.

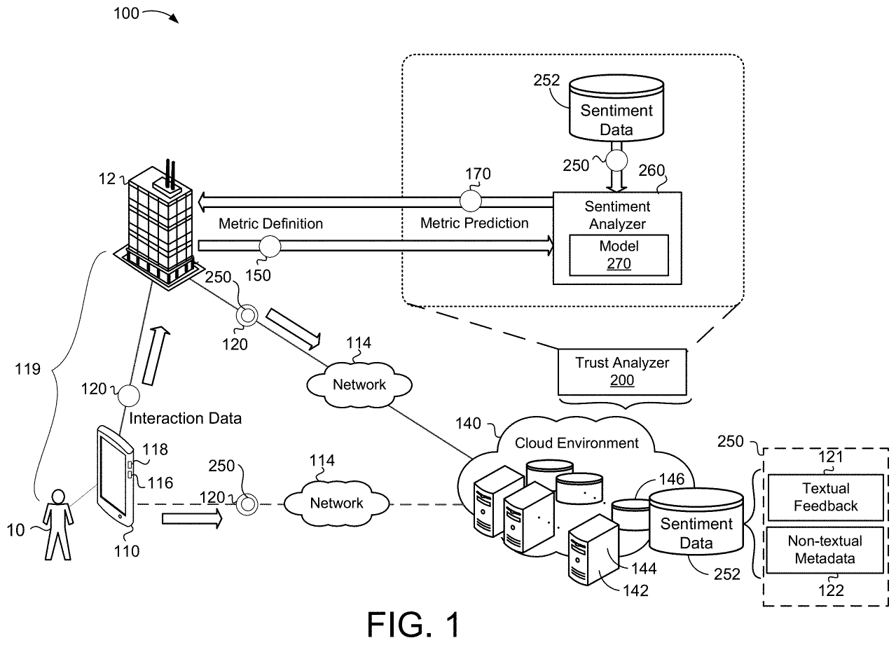

Referring to FIG. 1, in some implementations, a system 100 includes a user device 110 (e.g., customer device) that collects interaction data 120 representing one or more interaction 119 between a user 10 (e.g., customer) associated with the user device 110 and an entity 12. The user device 110 may correspond to any computing device, such as a desktop workstation, a laptop workstation, a smart speaker, or a mobile device (i.e., a smart phone). The user device 110 includes computing resources 118 (e.g., data processing hardware) and/or storage resources 116 (e.g., memory hardware). The interaction data 120 is data generated by the user 10 and stored by the entity 12 (e.g., a business or company). For example, the user 10 may interact with the entity via a call to customer support, an email, an online chat interface, social media posts, a purchase of a product, etc. The user 10 may generate the interaction data 120 via the user device 110 through, for example, a phone call, a web browser, or other application executing on the user device 110. The interaction data 120 may characterize, represent, and/or include sentiment data 250 which may be in the form of textual feedback data 121 and/or non-textual metadata 122. Though not illustrated, the entity 12 may obtain interaction data 120 from other remote devices communicatively coupled to the entity 12.

The entity 12 communicates the interaction data 120 to a remote system 140 via, for example, a network 114. The remote system 140 may be a distributed system (e.g., cloud computing environment) having scalable/elastic resources 142. The resources 142 include computing resources 144 (e.g., data processing hardware) and/or storage resources 146 (e.g. memory hardware). In some implementations, the remote system 140 executes a trust analyzer 200 configured to receive the interaction data 120 from the entity 12. Optionally, the remote system 140 receives some or all of the interaction data 120 directly from the user device 110 (via the same or different network 114).

In some examples, the trust analyzer 200 obtains a metric definition 150 from the entity 12. As described in more detail below, the metric definition 150 defines a customer trust target metric customized by the entity 12. The trust analyzer 200, using the interaction data 120 and the metric definition 150, returns a predicted customer trust target metric 170. The predicted customer trust target metric 170 (also referred to herein as the “metric prediction”) represents an estimated customer trust or sentiment of the user 10 with the entity 12.

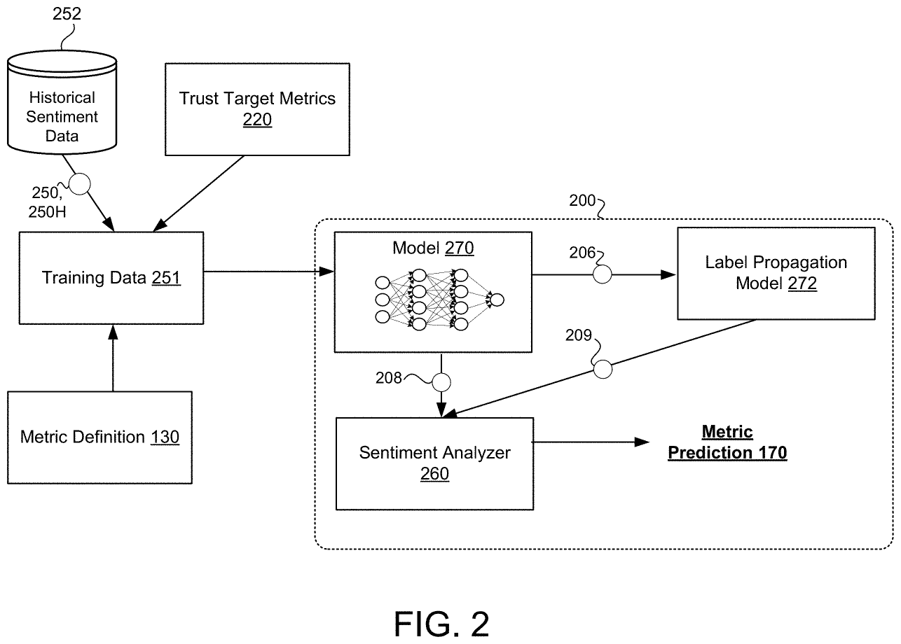

In the example shown, the trust analyzer 200 includes a sentiment analyzer 260. The sentiment analyzer 260 generates a sentiment score 208 (FIG. 2) that estimates or predicts a sentiment the user 10 holds regarding the entity 12. Using the sentiment score 208 and the metric definition 150, the sentiment analyzer 260 determines or predicts the customer trust target metric 170 for one or more of the interactions 119 (characterized by the interaction data 120) between the user 10 and the entity 12. The trust analyzer provides or sends the determined customer trust target metric 170 to the entity 12. While examples herein describe the entity 12 as separate from the remote system 140, it is understood that the remote system may be a part of or otherwise associated with the entity 12.

In some examples, the sentiment analyzer 260 uses a natural language processing model 270 (also referred to herein as just “the model 270”) configured to receive the sentiment data 250 (e.g., via a sentiment datastore 252 populated by the interaction data 120 received from the entity 12) as well as the metric definition 150 provided by the entity 12. The sentiment data 250 derived from the interaction data 120 includes textual feedback 121 and non-textual metadata 122. The model 270 uses the sentiment data 250 and the metric definition 150 to predict the customer trust target metric 170. Described in greater detail below, the model 270 may be trained on training data 251 (FIG. 2) that includes corresponding interaction data 120 including textual feedback 121 and non-textual metadata 122, the metric definition 150, and actual trust target metrics 220.

The natural language processing of the trust analyzer 200 helps to remedy deficiencies of known language processing models. For example, known models such as Latent Dirichlet Allocation, Universal Sentence Encoder, and Generic Sentiment Analysis models each have limitations that render them inapplicable to similar systems. For example, these models are limited in scalability and cannot process multiple languages simultaneously. Further, some known methodologies are based on word-gram techniques and cannot identify similar words. For example, word-gram methodologies cannot identify that the phrases “it is sunny today” and “it is bright today” have a similar meaning. The model 270 is capable of analyzing large sets of user interaction data 120 characterizing sentiment data 250 from numerous users 10 in order to accurately predict a customer trust target metric for each user 10. In order to achieve the intended functionality, the language processing model 270 is trained to analyze large data sets and recognize and group similar interactions 119.

Referring now to FIG. 2, in some implementations, the natural language processing model 270 is trained on training data 251 which includes historical sentiment data 250, 250H obtained from a sentiment data store 252. As discussed above, the sentiment data 250 may be received as interaction data 120 indicative of a number of interactions 119 between the user 10 and the entity 12 and may include textual feedback 121 as well as non-textual metadata 122. The sentiment data store 252 may reside on the storage resources 146 of the distributed system 140 or may reside at another location in communication with the remote system 140. Additionally or alternatively, sentiment data 250 may be obtained from external devices communicatively coupled to the system 100. In some examples, the interaction data 120 communicated from the user device 110 to the entity 12 includes audio data, whereby the entity 12 or the remote system 140 executes an automated speech recognition (ASR) engine to convert the audio data into corresponding textual feedback 121

In some examples, the training data 251 includes the metric definition 150 and actual trust target metrics 220. The metric definition 150 is an indication of how the metric prediction 170 should be configured, as defined by the entity 12. In some implementations, the metric definition 150 is a survey response. For example, the metric definition 150 may be a numerical score on a scale of 1-5, 1-10, 1-100, etc, or may simply be a binary score of one (1) for a positive user indication of trust and zero (0) for negative user indication of trust. In another example, the metric definition may be a selection of a number of icons, such as a series of emoticons (e.g., a “thumbs up” or a “smiley face”). Put another way, the metric definition 150 defines to the trust analyzer 200 the format the entity 12 desires the customer trust target metric 170. This allows the entity 12 to, for example, align the format of the customer trust target metric 170 with format the entity 12 traditionally obtains sentiment data 250 (e.g., survey responses, etc.).

Training of the model 270 is configured based on the provided metric definition 150. In other words, the model 270, instead of being trained to produce, for example, a numeric score, is specifically trained based on the desired metrics defined by the metric definition 180 so that the metric prediction 170 is in a format defined by the metric definition 150.

The actual trust target metrics 220 may be known or accepted trust targets previously defined or determined. For example, the entity 12 may have previously defined certain interactions or responses based on the metric definition 150. In some implementations, the entity 12 establishes actual trust target metrics 220 based on received survey responses from one or more users 10.

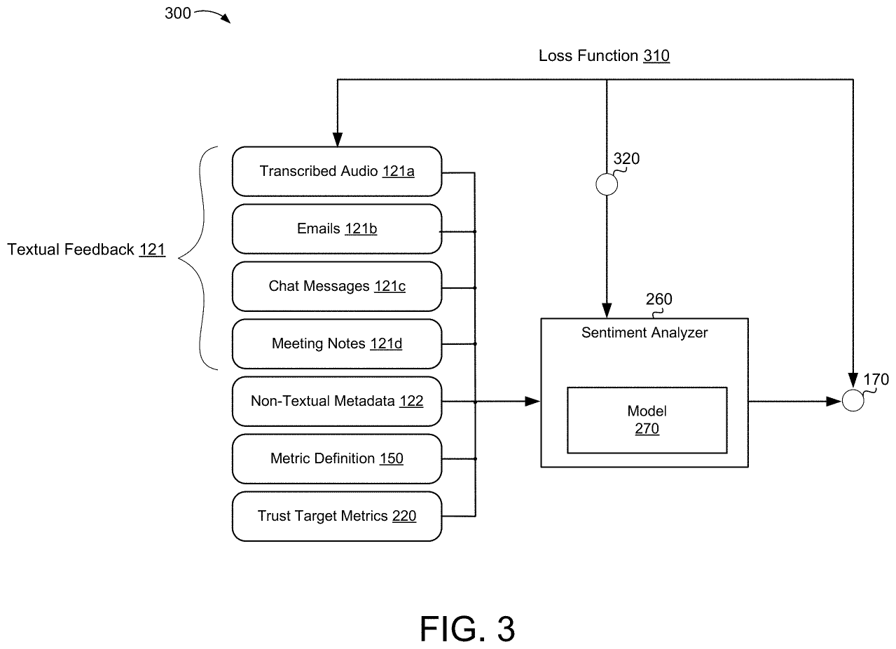

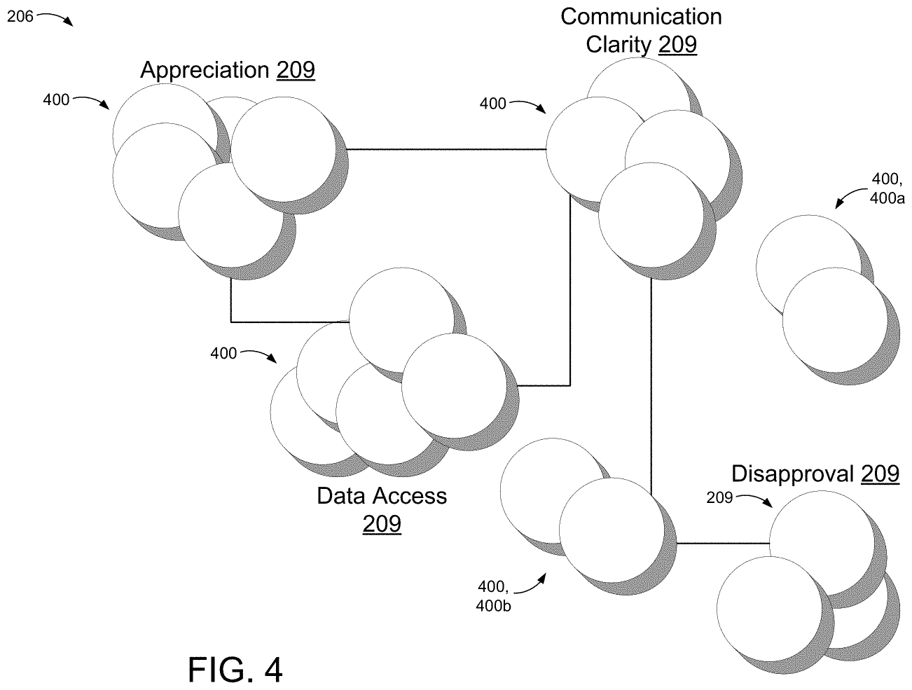

In the example shown, the trust analyzer 200 provides the training data 251 to the model 270 for training. The process of training model 270 is discussed in greater detail below with reference to FIG. 3. Once trained, the trained model 270 may analyze sentiment data 250 to generate a graph 206 for use by a label propagation model 272. The graph 206 may be a word cluster or a number of interconnected nodes (FIG. 4) as described in more detail below. In some implementations, the natural language processing model 270 may process textual feedback 121 to generate the graph 206. For example, the natural language processing model 270 may generate the graph 206 using contextual graph-based sampling of the sentiment data 250, including textual feedback data 121 and/or non-textual metadata 122. In other words, the model 270 may arrange sentiment data 250 in clusters based on the determined context of the sentiment data 250 until all of the sentiment data 250 is mapped to a position on the graph 206.

The label propagation model 272 may be trained using a semi-supervised algorithm to efficiently expand high-quality human label data to non-labeled data to provide a large volume of training data for topic modeling. For example, the label propagation model 272 initially labels the nodes of the graph 206. The label propagation model 272 may receive feedback in the form of human labeled nodes of the graph 206.

The label propagation model 272 may alter future labels (i.e., topics 209) based on the received human label. In some implementations, a human will initially label the nodes of the graph 206. In other implementations, a human will alter the word clusters such that the nodes of the graph 206 are altered. In still other implementations, the label propagation model 272 selects one or more labels for human labelling. In any case, the label propagation model 272 may learn from the input (i.e., the labelling) provided by a human and alter future outputs accordingly.

In some implementations, the sentiment analyzer 260 generates one or more topics 209 associated with the one or more interactions 119 (FIG. 1) between the user 10 and the entity 12 characterized by the interaction data 120. The topics 209 influence the predicted customer trust target metric 170. That is, the topics 209 highlight specific portions of the interaction data 120 that likely had significant influence on the predicted customer trust target metric 170. The label propagation model 272 may use the labelled graph 206 to determine one or more topics 209 associated with the one or more interactions 119 between the user 10 and the entity 12. In some implementations, the label propagation model 272 determines the topics 209 by converting the textual feedback data 121 into numerical inputs. For example, the label propagation model 272 uses language embedding to transform the textual feedback data 121 to one or more numerical outputs. The label propagation model 272 may arrange the numerical outputs in clusters of numeric ranges and label each cluster with a topic 209 accordingly.

The topics 209 indicate potential influences of the predicted customer trust target metric 170. For example, the topics 209 highlight areas for improvement as well as areas of success for the business, as discussed in greater detail below with respect to FIG. 4. In some implementations, the topics 209 are based on the labels generated from the graph 206.

With continued reference to FIG. 2, the model 270, after training, determines the sentiment score 208 based, at least in part, on the sentiment data 250. The sentiment score 208 generally reflects the customer trust target metric 170 based on one or more interactions 119 between the user 10 and the entity 12. The sentiment analyzer 260 may perform additional analysis on the sentiment score 208 based on the topics 209 to determine a final predicted customer trust target metric 170.

The natural language processing model 270 (and similarly the label propagation model 272) may include a neural network. For instance, the model 270 maps the training data 251 to output data to generate the neural network model 270. Generally, the model 270 generates hidden nodes, weights of connections between the hidden nodes, and input nodes that correspond to the training data 251, weights of connections between the hidden nodes and output nodes, and weights of connections between layers of the hidden nodes themselves. Thereafter, the fully trained neural network model 270 may be employed against input data (e.g., inference using the interaction data 120) to generate predictions (e.g., the metric prediction 170). In some examples, the neural network model 270 is a deep neural network (e.g., a regressor deep neural network) that has a first hidden layer and a second hidden layer. For example, the first hidden layer may have sixteen nodes and the second hidden layer may have eight nodes. The model 270 is typically trained in batches. That is, a model 270 is typically trained on a group of input parameters at a time. Once trained, the models 270 and 272 are used by trust analyzer 200 during inference for determining the metric predictions 170.

Though the actions of the trust analyzer 200 are depicted and described as a number of sequential operations by a number of components 270, 272, and 260, it should be understood that the figures and description are not intended to be limiting. Any suitable number of models may be implemented to produce the sentiment score 208, the graph 206, the topics 209, and the metric prediction 170.

Referring now to FIG. 3, the sentiment analyzer 260 may be configured to receive a plurality of inputs (i.e., sentiment data 250) associated with the predicted customer trust target metric 170. For example, as shown in schematic view 300, the inputs include textual feedback data 121, non-textual metadata 122, the metric definition 150, and the actual trust target metrics 220. Textual feedback 121 may include transcribed audio data 121, 121a, emails 121, 121b, chat messages 121, 121c, meeting notes 121, 121d, and/or any other textual data representative of the user's relationship or interactions with the entity 12. Transcribed audio data 121a may include transcripts of any calls between the user 10 and the entity 12, such as calls to a customer support line or a sales call. Emails 121b may include any emails exchanged between the user 10 and the entity 12, such as order confirmation emails, customer support emails, etc. Chat messages 121c may include any correspondence between the user 10 and entity 12 through a chat program, such as a chat box on a website. Meeting notes 121d may include any notes in a customer account. For example, a support technician of the entity 12 may add notes during a customer support call with the user 10 explaining difficulties the customer is facing with the entity 12.

Non-textual metadata 122 can include any data indicative of the user's 10 relationship with the entity that is not communicative (i.e., a direct or indirect communication between the user 10 and the entity 12). For example, the user's purchase history, return history, length of time the customer has been associated with the business, a quantity of the one or more interactions, or a subscription level associated an account of the user 10 are all non-textual metadata 122 that can be used by the sentiment analyzer 260 to predict the sentiment score 250 and/or the customer trust target metric 170. As described above, the metric definition 150 may be a specific metric selected by the entity 12 for displaying the customer trust target metric 170. The model 270 is trained based on the metric definition 150.

Using one or more of the inputs 121, 122, 150, 220, the sentiment analyzer 260 predicts the customer trust target metric 170 by using the model 270 to determine one or more graphs 206, a sentiment score 208, and/or topics 209. During training and/or as additional actual trust target metrics 220 are obtained, the sentiment analyzer 260 may determine a loss 320 between the predicted customer trust target metric 170 and the actual trust target metrics 220. That is, the sentiment analyzer 260 may use a loss function 310 (e.g., a mean squared error loss function) to determine a loss 320 of the customer trust target metric 170, where the loss 320 is a measure of how accurate the predicted customer trust target metric 170 is relative to the actual trust target metric 220. The sentiment analyzer 260, in some implementations, uses the loss 320 to further train or tune the model 270 (and or label propagation model 272).

In some examples, the sentiment analyzer 260 tunes the model 270 with the loss 320 and/or any associated inputs 121, 122, 130 immediately after the sentiment analyzer 260 receives an actual trust target metric 220 via a survey. For example, at some point in time after the sentiment analyzer 260 predicts customer trust target metric 170 for one or more interactions 119 between the user 10 and the entity 12, the user 10 submits a survey providing the actual trust target metric 220. The sentiment analyzer 260, via the loss function 310, may further tune or train the model 270 using the actual trust target metric 220 received from the user 10 or entity 12.

In other examples, the sentiment analyzer 260 trains the model 270 at a configurable frequency. For example, the sentiment analyzer 260 may train the model 270 once per day. It is understood that the configurable frequency is not limited to once per day and may include any other period of time (e.g., once per hour, once per week, etc.). For example, the sentiment analyzer 260 may train the model 270 automatically once per day (or some other predetermined period of time) to tune the model 270 based on the prior day's data. In some implementations, the loss 320 of the tuned or retrained model 270 is compared against the loss of a previous model 270 (e.g., the model 270 trained from the previous day), and if the loss 320 of the new model 270 satisfies a threshold relative to the loss 320 of the previous model 270 (e.g., the loss 320 of the model 270 trained today versus the loss 320 of the model 270 trained yesterday), the wait sentiment analyzer 260 may revert to the previously trained model 270 (i.e., discard the newly tuned or retrained model 270). Put another way, if the model 270 is further trained on new training data (e.g., actual trust target metric 220), but the loss 320 indicates that the accuracy of the model 270 has declined, the model 270 may revert to the previous, more accurate model 270.

Referring back to FIG. 1, the trust analyzer 200, based on the inputs 121, 122, 130, and 220 predicts the customer trust target metric 170 for the entity 12. Any outputs of the trust analyzer 200 (including the graphs 206, sentiment score 208, topics 209, and predicted customer trust target metric 170) may be transmitted for display to a device of the entity 12. The entity 12 device may correspond to a computing device, such as a desktop workstation, laptop workstation, mobile device (e.g., smart phone or tablet), wearable device, smart appliance, smart display, or smart speaker. That is, the entity 12 device can be any computing device capable of communicating with the remote system 140 through the network 114.

FIG. 4 illustrates an example graph 206 as produced by the model 270, including topics 209. In this example, the graph 206 is a cluster graph generated using contextual graph-based sampling of the sentiment data. Here, each sampled node represents a cluster of the graph for labelling. The clusters of the graph 206 include sentiment data corresponding to one or more customer interactions 119 that are similar in nature. For example, a transcription of a call where a customer uttered the phrase “your service has been outstanding” might be clustered with an email where a customer wrote “gracias port u ayuda, to lo agredezco” (i.e., Spanish for “thanks for your help, I appreciate it”) under the node labelled “Appreciation.” In some implementations, there may be clusters that are not labelled, such as clusters 400, 400a and 400, 400b. In these implementations, a manual operator may place a label on these clusters 400a, 400b creating another node. Alternatively, the operator may move the clusters 400a, 400b under a labelled node. In yet other implementations, a manual operator edits the labels or otherwise manipulates the graph 206. As discussed above, any changes implemented by a human may be analyzed by the label propagation model 272 and the label propagation model 272 may adjust one or more algorithms such that future labelling and clustering of nodes reflect the human-made changes.

The topics 209 can give insight to the entity 12 into the areas of good performance as well as areas of poor performance. In the example graph 206 of FIG. 4, the entity 12 may infer from the topics 209 that users 10 are having issues with data access as well as communication clarity. In some implementations, sentiment data 250 corresponding to the topics 209 may be retrievable such that the entity 12 may further analyze some of the underlying issues corresponding to the topics 209.

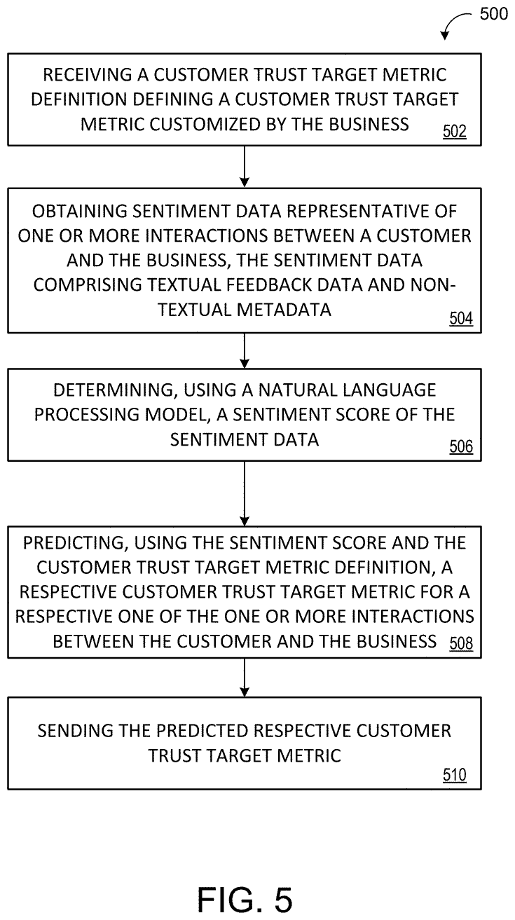

FIG. 5 is a flowchart of an example arrangement of operations for a method 500 of determining a customer trust target metric (i.e., metric prediction 170). The method 500 may be described with reference to any of FIGS. 1-4. The method 500 begins at operation 502 by receiving a customer trust target metric definition 150 defining a customer trust target metric 170 customized by the business 12. The method 500, at operation 504, includes obtaining sentiment data 250 representative of one or more interactions 119 between a customer 10 and the business 12. The sentiment data 250 includes textual feedback 121 and non-textual metadata 122. At operation 506, the method 500 includes determining, using a natural language processing model 270, a sentiment score 208 of the sentiment data 250. The method 500 also includes, at operation 508, predicting, using the sentiment score 208 and the customer trust metric definition 150, a respective customer trust target metric 170 for a respective one of the one or more interactions 119 between the customer 10 and the business 12. At operation 510, the method 500 includes sending, to the business 12, the predicted respective customer trust target metric 170.

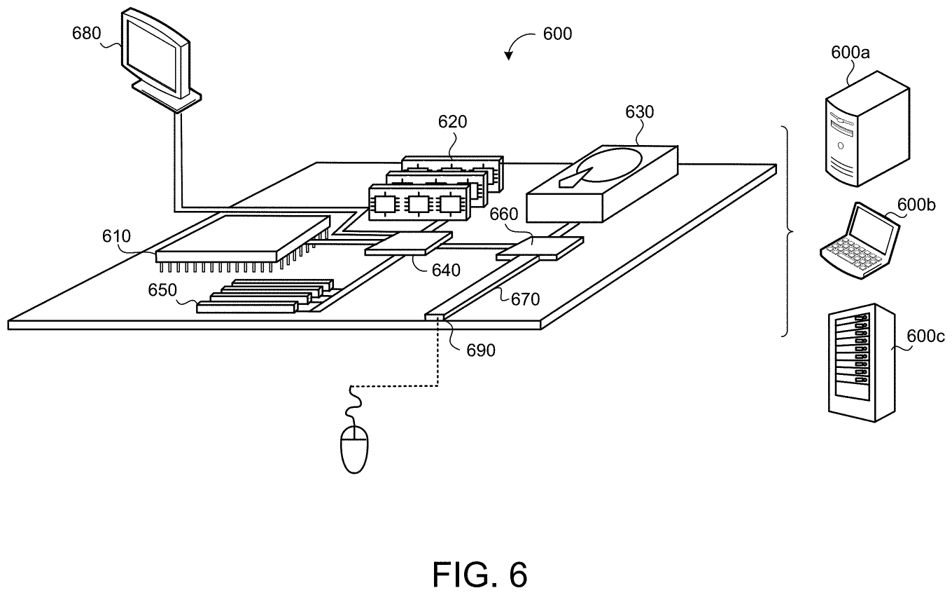

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various buses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs).

Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by 0 which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
receiving, from a business, a customer trust target metric definition defining a customer trust target metric customized by the business;
obtaining sentiment data representative of one or more interactions between a customer and the business, the sentiment data comprising textual feedback data and non-textual metadata;
determining, using a natural language processing model, a sentiment score of the sentiment data;
predicting, using the sentiment score and the customer trust target metric definition, a respective customer trust target metric for a respective one of the one or more interactions between the customer and the business; and
sending, to the business, the predicted respective customer trust target metric.

2. The method of claim 1, wherein the customer trust target metric comprises a survey response.

3. The method of claim 1, wherein the operations further comprise, prior to determining the sentiment score, training the natural language processing model using historical sentiment data, actual trust target metrics provided by customers, and the customer trust target metric definition.

4. The method of claim 1, wherein the non-textual metadata comprises at least one of a length of time the customer has been associated with the business, a quantity of the one or more interactions, or a subscription level associated with the customer.

5. The method of claim 1, wherein the textual feedback data comprises at least one of transcribed audio conversations, emails, chat messages, or meeting notes.

6. The method of claim 1, wherein the operations further comprise determining, using the natural language processing model and the sentiment data, one or more topics associated with the one or more interactions between the customer and the business that influence the predicted respective customer trust target metric.

7. The method of claim 6, wherein determining the one or more topics comprises converting, using a language embedding, the textual feedback data into numerical inputs.

8. The method of claim 6, wherein determining the one or more topics comprises generating a graph using contextual graph-based sampling of the sentiment data.

9. The method of claim 8, wherein determining the one or more topics comprises selecting a plurality of nodes of the graph for human labeling.

10. The method of claim 9, wherein determining the one or more topics comprises:
training, using the plurality of human labeled nodes, a label propagation model; and
predicting, using the label propagation model, a label for each node of the graph.

11. A system comprising:
data processing hardware; and
memory hardware in communication with the data processing hardware, the memory hardware storing instructions that when executed on the data processing hardware cause the data processing hardware to perform operations comprising:
receiving, from a business, a customer trust target metric definition defining a customer trust target metric customized by the business;
obtaining sentiment data representative of one or more interactions between a customer and the business, the sentiment data comprising textual feedback data and non-textual metadata;
determining, using a natural language processing model, a sentiment score of the sentiment data; and
predicting, using the sentiment score and the customer trust target metric definition, a respective customer trust target metric for a respective one of the one or more interactions between the customer and the business.

12. The system of claim 11, wherein the customer trust target metric comprises a survey response.

13. The system of claim 11, wherein the operations further comprise, prior to determining the sentiment score, training the natural language processing model using historical sentiment data, actual trust target metrics provided by customers, and the customer trust target metric definition.

14. The system of claim 11, wherein the non-textual metadata comprises at least one of a length of time the customer has been associated with the business, a quantity of the one or more interactions, or a subscription level associated with the customer.

15. The system of claim 11, wherein the textual feedback data comprises at least one of transcribed audio conversations, emails, chat messages, or meeting notes.

16. The system of claim 11, wherein the operations further comprise determining, using the natural language processing model and the sentiment data, one or more topics associated with the one or more interactions between the customer and the business that influence the predicted respective customer trust target metric.

17. The system of claim 16, wherein determining the one or more topics comprises converting, using a language embedding, the textual feedback data into numerical inputs.

18. The system of claim 16, wherein determining the one or more topics comprises generating a graph using contextual graph-based sampling of the sentiment data.

19. The system of claim 18, wherein determining the one or more topics comprises selecting a plurality of nodes of the graph for human labeling.

20. The system of claim 19, wherein determining the one or more topics comprises:
training, using the plurality of human labeled nodes, a label propagation model; and
predicting, using the label propagation model, a label for each node of the graph.
